(19) United States
(12) Patent Application Publication
(10) Pub. No.: US 2020/0204514 A1
(43) Pub. Date: Jun. 25, 2020

(54) PRIORITIZED MESSAGING SYSTEM

(71) Applicant: Shopify Inc., Ottawa (CA)

(72) Inventor: Michael Leander Perry, Oakland, CA (US)

(21) Appl. No.: 16/228,876

(22) Filed: Dec. 21, 2018

(51) Int. Cl. H04L 12/58; G06Q 10/10; G06Q 30/02; G06N 7/00

(52) U.S. Cl. CPC H04L 51/26; H04L 51/02; G06N 7/005; G06Q 30/02; G06Q 10/107

(57) ABSTRACT

Devices, systems and methods are provided herein for identifying and displaying a message priority including receiving a plurality of messages; for each message, assigning a message priority based upon at least one of a message content, a recipient identity, a sender identify, a messaging platform of the message and a message age; displaying the messages according to the assigned message priority of the message; and wherein the message priority is at least partially based upon factors relating to the recipient of the message in relation to at least one of the content of the message and the identity of the sender.

### FIELD

The present disclosure relates generally to received message management and selective automated reply, and more particularly to displaying electronic messages based upon content, sender information and recipient information with a prioritized or enhanced display developed from message content, sender and/or recipient to allow respondents to first interact with messages of a predetermined level of importance or to provide automated responses to messages of a predetermined level of importance.

### BACKGROUND

Electronic messaging, such as email, text messaging, and messaging through particular apps has become ubiquitous not only for personal communication, but also for business communication. For example, communication between buyers, sellers, distributors, and providers and manufacturers of products and services now commonly takes place using various forms of electronic communication. The ease with which sellers and consumers can communicate electronically has led to the volume of such communications to become potentially overwhelming. As an increasingly popular method of communication, larger numbers of people are able to use various electronic messaging platforms to inundate sellers of products and services with messages that are of a varying degree of relevance and importance to the seller but are not easily differentiated.

Some messages are of great importance to sellers because they relate to more serious customers or more important subject matter in relation to the product or service being sold. Many other messages are from less serious buyers (or nonbuyers) and/or relate to information that is actually not relevant to the product or service at hand or easily answered by an automated process. It is extremely difficult or impossible for sellers to precisely separate or prioritize these messages so that important messages are dealt with first or by higher level seller-responders and lower level messages are handled by lower level seller-responders or automated agents.

Therefore, there is a need in the art for systems that provide a prioritized or enhanced display of messages using inputs to order, segregate, ignore and/or route electronic messages to human or automated systems for response.

### SUMMARY

Methods are provided herein for identifying a message priority. The methods include receiving a plurality of messages; for each message, assigning a message priority based upon at least one of a message content, a recipient identity, a sender identify, a messaging platform of the message and a message age; displaying the messages according the assigned message priority of the message; and wherein the message priority is at least partially based upon factors relating to the recipient of the message in relation to at least one of the content of the message and the identity of the sender.

In other embodiments of the methods, the step of displaying the messages according to the assigned message priority of the message comprises displaying the message according to the assigned message priority of the message by ordering the messages according to rules of priority.

In other embodiments, the methods further include a step of, for each message, assigning a message priority based upon at least one of a message content, a recipient identity, a sender identify, a messaging platform of the message and a message age which comprises assigning a score to the message based upon at least one of the message content, the recipient identity, the sender identify, the messaging platform of the message and the message age.

In other embodiments, the methods further include the step of determining whether to respond to one or more of the plurality of messages with an automated agent based upon the assigned priority.

In other embodiments of the methods, the plurality of messages is received over a plurality of messaging platforms.

In other embodiments of the methods, the message priority is a score calculated from a first score based upon organizational message priority and a second score based upon agent message priority based upon the factors relating to the recipient of the message.

Also provided is a device comprising a processor and a computer-readable storage device that stores instructions that, when executed by the processor, cause the processor to perform operations, including: receiving a plurality of messages; for each message, assigning a message priority based upon at least one of a message content, a recipient identity, a sender identify, a messaging platform of the message and a message age; displaying the messages according to the assigned message priority of the message; and wherein the message priority is at least partially based upon factors relating to the recipient of the message in relation to at least one of the content of the message and the identity of the sender.

In other embodiments of the device the operation of displaying the messages according to the assigned message priority of the message comprises displaying the message according to the assigned message priority of the message by ordering the messages according to rules of priority.

In other embodiments of the device the operation of, for each message, assigning a message priority based upon at least one of a message content, a recipient identity, a sender identify, a messaging platform of the message and a message age comprises assigning a score to the message based upon at least one of the message content, the recipient identity, the sender identify, the messaging platform of the message and the message age.

In other embodiments of the device, causing the processor to perform operations comprises determining whether to respond to one or more of the plurality of messages with an automated agent based upon the assigned priority.

In other embodiments of the device, the plurality of messages is received over a plurality of messaging platforms.

In other embodiments of the device, the message priority is a score calculated from a first score based upon organizational message priority and a second score based upon agent message priority based upon the factors relating to the recipient of the message.

Also provided is a computer-implemented method, the method including the steps of receiving a plurality of messages relating to purchasing of products or services; assigning a message priority to each message based upon at least one of a message content, a recipient identity, a sender identify, a messaging platform of the message and a message age; identifying keywords associated with the message for purchasing of the products or services; categorizing the keywords associated with the message; determining a response to the message based upon the categorization of the keywords; developing a confidence level for the keywords that indicate a statistical probability that an answer is relevant to the message; and transmitting the response if the confidence level for the keywords exceeds a predetermined confidence level.

In other embodiments of the method, the step of assigning a message priority based upon at least one of a message content, a recipient identity, a sender identify, a messaging platform of the message and a message age comprises assigning a score to the message based upon at least one of the message content, the recipient identity, the sender identify, the messaging platform of the message and the message age.

In other embodiments of the method, the step of determining whether to respond to one or more of the plurality of messages with an automated agent is based upon the assigned priority.

In other embodiments of the method, the message priority is a score calculated from a first score based upon organizational message priority and a second score based upon agent message priority based upon factors relating to the automated agent.

In other embodiments of the method, the plurality of messages is received over a plurality of messaging platforms.

Also provided is a system including a processor and a computer-readable storage device that stores instructions that, when executed by the processor, cause the processor to perform operations comprising: transmitting to a client device data to display a plurality of messages related to a product or service for purchase from an online merchant, wherein the data includes software instructions for execution by the client device, wherein the software instructions cause the client device to perform steps for assigning a message priority to each message based upon at least one of a message content, a recipient identity, a sender identify, a messaging platform of the message and a message age; and for displaying the plurality of messages, and wherein the software instructions cause the client device to display the plurality of messages according to the assigned message priority of each message.

In other embodiments of the system, the software instructions causing the client device to display the plurality of messages comprise software instructions causing the client device to display the messages according to the assigned message priority of each message by ordering the messages according to rules of priority.

In other embodiments of the system, the software instructions causing the client device to, for each message, assign a message priority based upon at least one of a message content, a recipient identity, a sender identify, a messaging platform of the message and a message age which comprises software instructions causing the client device to assign a score to the message based upon at least one of the message content, the recipient identity, the sender identify, the messaging platform of the message and the message age.

In other embodiments of the system, the software instructions cause the client device to determine whether to respond to one or more of the plurality of messages with an automated agent based upon the assigned priority.

In other embodiments of the system, the plurality of messages is received over a plurality of messaging platforms.

In other embodiments of the system, the message priority is a score calculated from a first score based upon organizational message priority and a second score based upon agent message priority based upon factors relating to the recipient of the message.

### BRIEF DESCRIPTION OF THE FIGURES

FIG. 1 depicts an embodiment of an e-commerce platform.

FIG. 2 depicts an embodiment of a home page of an administrator.

FIG. 3 depicts an embodiment of a communications platform.

FIG. 4 depicts a diagram of the operation of the communications platform.

FIG. 5 depicts an embodiment of a message display prior to prioritization.

FIG. 6 depicts an embodiment of a prioritized message display.

FIG. 7 depicts an embodiment of a hybrid prioritized and unprioritized message display.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

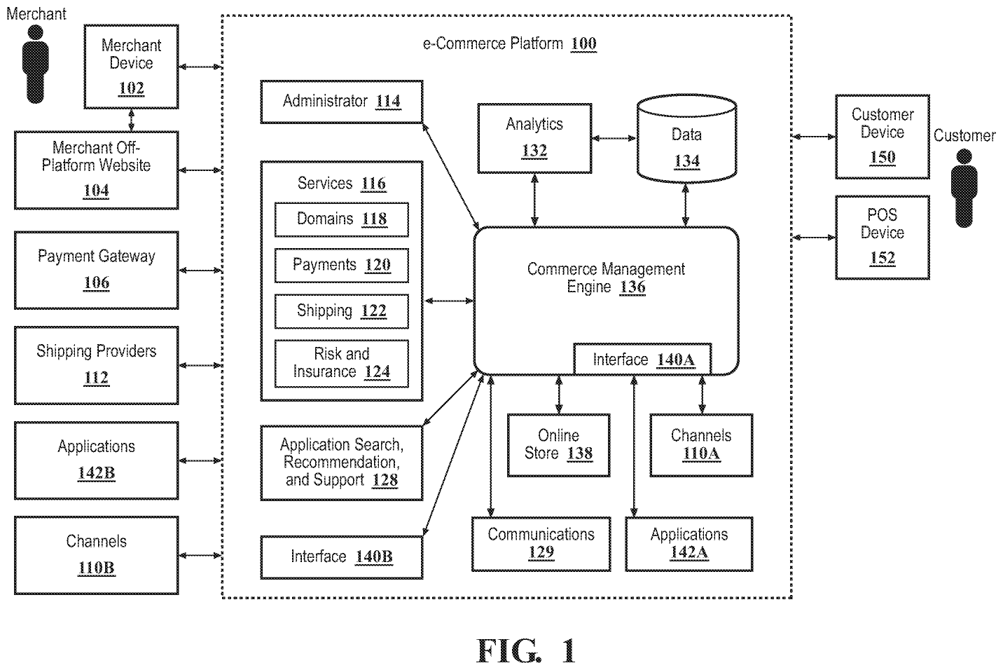

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as s service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

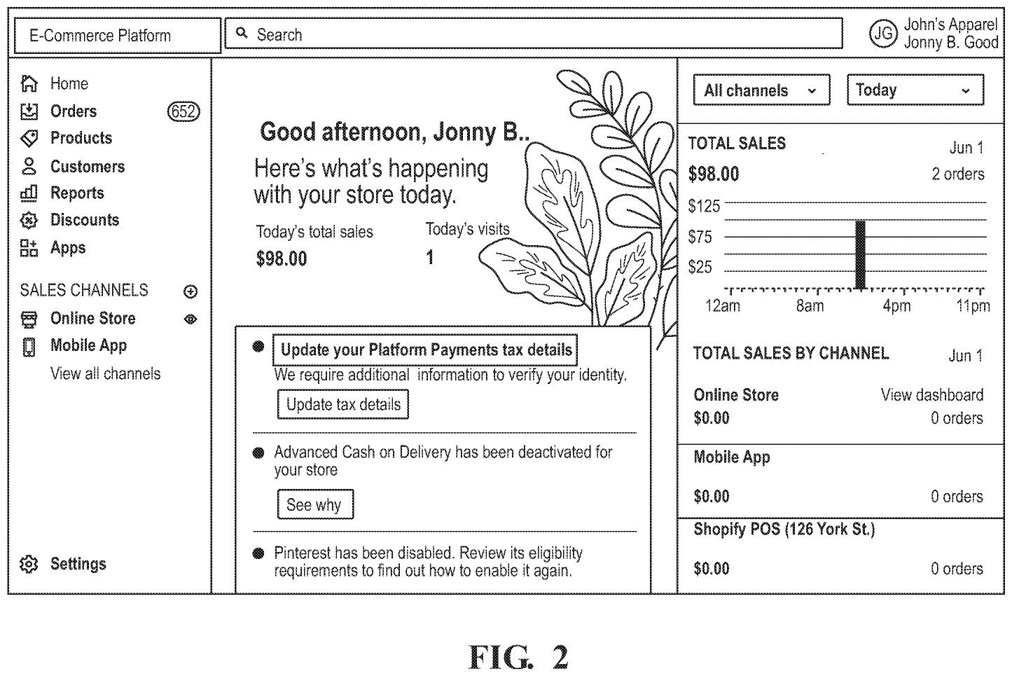

FIG. 2 depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

In an embodiment, the present disclosure relates generally to the receipt, prioritizing and reply to electronic messages within the e-commerce platform 100. In embodiments, the e-commerce platform 100 includes a communications component 129 that, in embodiments, may communicate directly through the commerce management engine 136. In alternative embodiments, the communication component 129 operates as an internal or external application 142A-B or otherwise communicates through an interface 140A-B. In alternative embodiments, the communication component 129 operates to enable customers and merchants located remotely from each other to communicate through a network, such as an electronic network (for example, a wide area network).

In another embodiment, the e-commerce platform 100 assists in marketing products and services to customers located in a physical retail location. In this embodiment, the e-commerce platform 100 may still be or include a communication platform for communicating over a network, such as the wide area network, and as further described herein.

The platform may further utilize a network to communicate with third parties as necessary to maintain and operate the e-commerce platform 100, such as, for example, remote buyer communication with users of the e-commerce platform 100 and clearing of payment transactions on the e-commerce platform 100. The e-commerce platform 100 may further be in electronic communication with merchant devices 102 and customer devices 150, including peripheral devices attached thereto, such as keyboards, mice, monitors, interactive displays, printers, cameras, and POS devices, such as for payment cards and mobile devices.

In embodiments, the platform 100 or communication component 129 may include a customer relationship management platform.

The communications component 129 may have access to various forms of electronic messaging, such as electronic mail, SMS or MMS text messaging, or other types of messaging accomplished through messaging services, such as Twitter, Facebook Messenger, WhatsApp, Snapchat, Viber, Instagram, WeChat, Skype, Slack, or any other messaging application. In embodiments, the communications platform includes access to voice (such as voice over IP and telephone) and video communications.

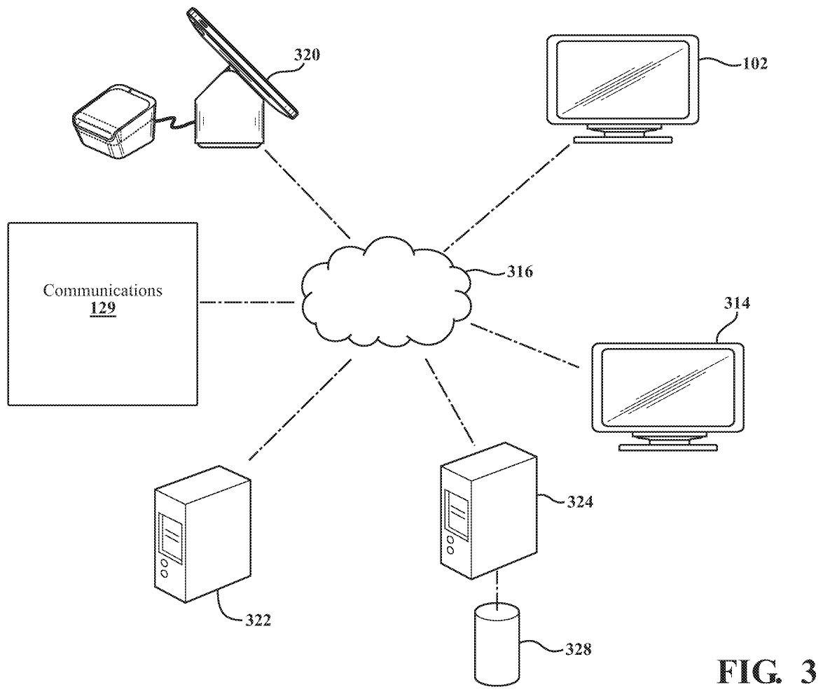

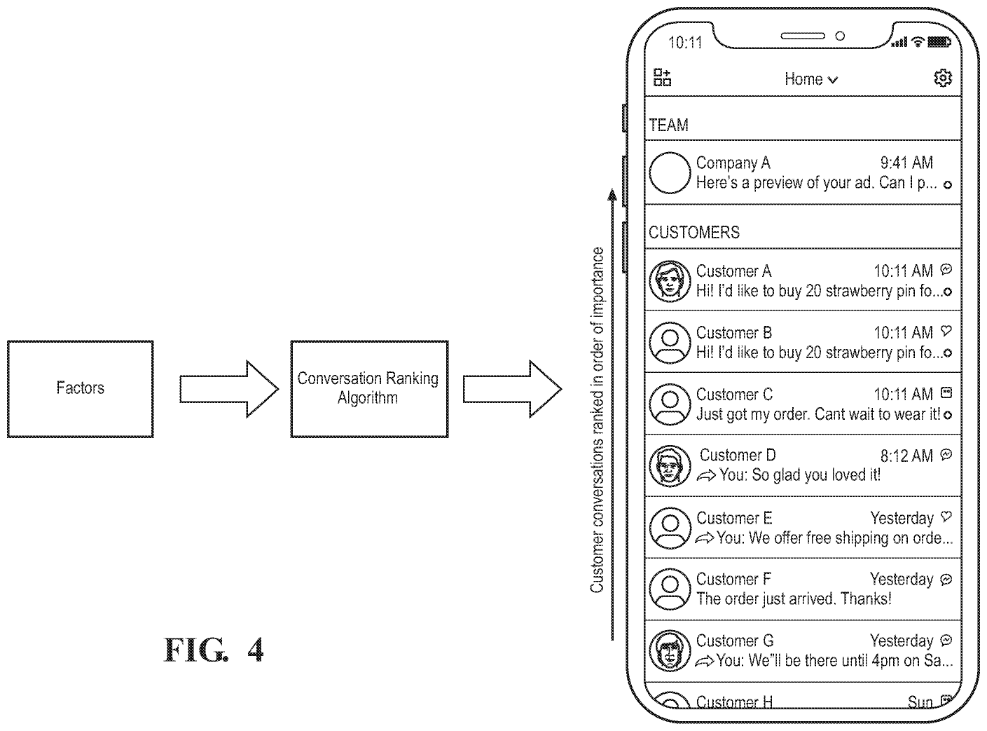

Referring to FIGS. 3 and 4, the communication component 129 may comprise one or more communications devices 322 which each facilitate the sending or receiving of electronic messaging with customers and other parties using remote devices 314 through a network 316. As described herein, the electronic messaging format can be one or many of any format such as email, SMS or MMS messaging, or other messaging services or modes of communication. The network 316 may comprise one or more networks that are adapted to accept and route such communications. The communication devices 322 may comprise devices of one or more third party external services, an email server and/or an SMS or MMS text message service.

In one embodiment, one or more electronic messaging aggregation devices 324 may query the one or more communication devices 322 to aggregate messages from multiple messaging services. In embodiments, any of the devices herein may be logical or software devices, as opposed to physical devices. The communication devices 322 may communicate with the communications component 129 or be incorporated therein. Further, the messaging aggregation devices 324 may communicate with the communications component 129 or be incorporated therein. In an embodiment, the messages from multiple messaging services are aggregated in a data store 328 associated with the messaging aggregation device 324. With the aggregation device 324, electronic messages may be analyzed, ordered, delivered, ignored, and/or responded to by the communications component 129, as further described herein. Alternatively, the messages may be presented to one or merchant devices 102 using logic described herein for manual or automated reply. In embodiments, multiple merchant devices 102 are monitored by multiple merchant users. In an alternative embodiment, a merchant device 102 may retrieve messages from the aggregation device 324 and the merchant device 102 alone may include software for analyzing, ordering, delivering and/or responding to the messages. In yet another alternative embodiment, the merchant device 102 may retrieve messages directly from the communication devices 322 and include software for analyzing, ordering, delivering and/or responding to the messages, in which case the e-commerce platform 100 would not include or communicate with an aggregation device 324. In yet still another embodiment, within the e-commerce platform 100, the POS devices 320 may implement the functions of the merchant device 102 for both retrieving the messages from the communication devices 322 and analyzing, ordering, delivering and/or responding to the messages.

In order to prioritize messages coming across all incoming message communication methods, the device responsible for analyzing and ordering messages, as described herein, uses algorithm inputs to rank message and/or conversation priority and then presents the message and/or conversation to the merchant or merchant users in a prioritized fashion and/or in an enhanced display. In embodiments, when displaying in a prioritized fashion, messages with higher priority are displayed above messages with a lower priority. Alternatively, messages are given a priority score and messages with a priority score above a particular threshold are displayed in priority score order and messages below a certain priority score are not displayed and replied to with an automated agent as described herein.

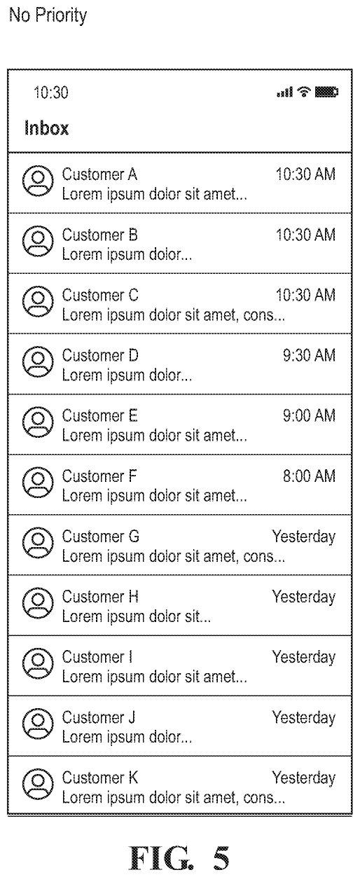

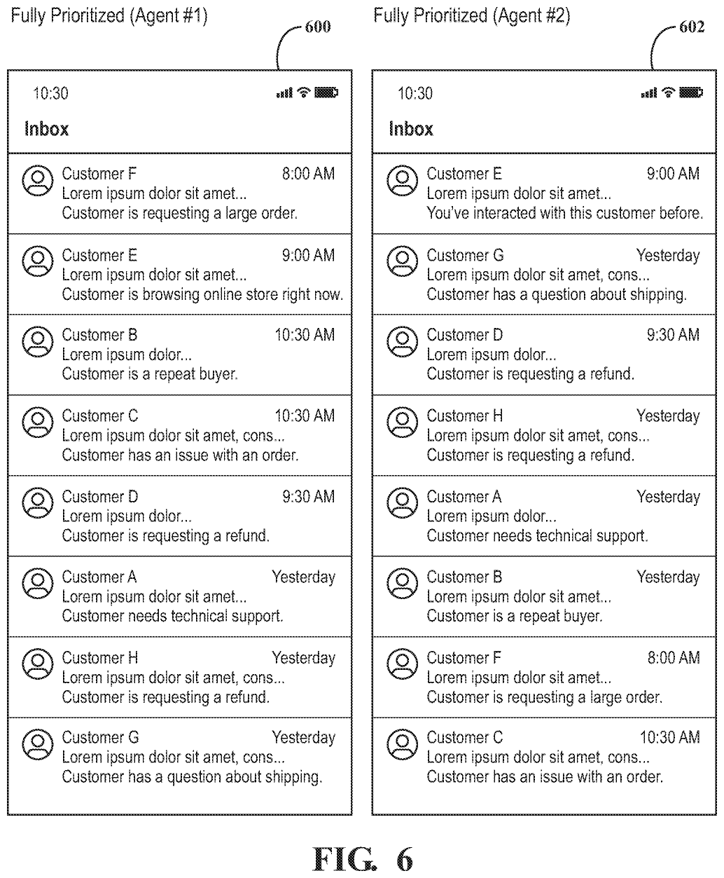

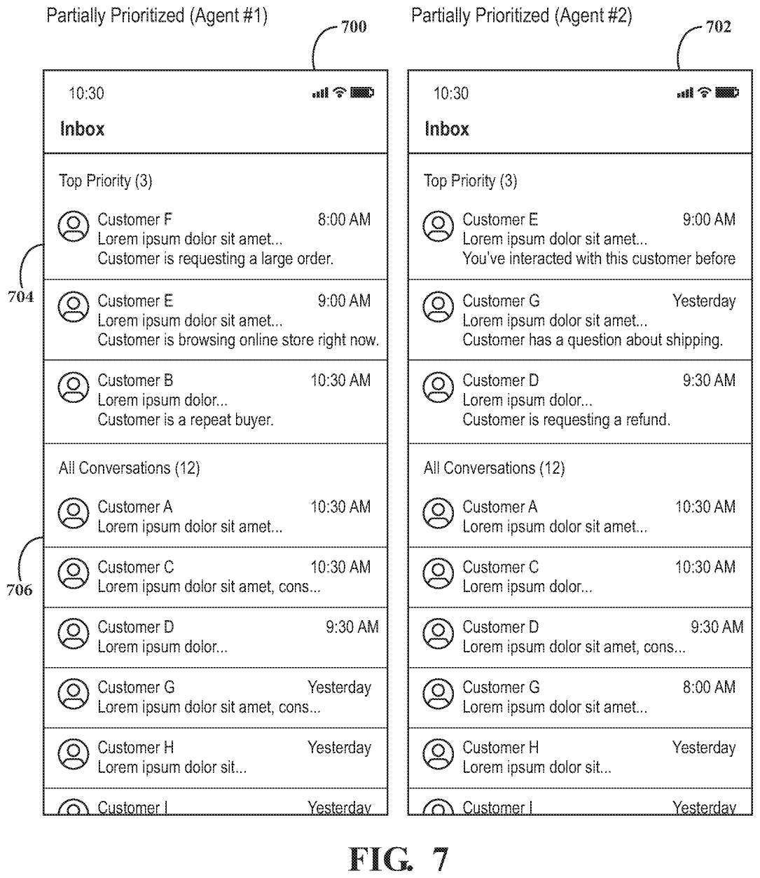

Referring to FIG. 5, messages may be displayed prior to prioritization or enhancement. When messages are displayed in an enhanced display, rather than a prioritized order, messages with higher priority may be displayed in different colors, fonts, font sizes, with different icons, in specified priority groups or in groups according to subject matter rather than in a prioritized order. In embodiments, messages may be presented in a combination of prioritized order and enhanced display. Referring to FIG. 6, prioritized message displays 600 and 602 for two example agents are provided where the prioritization of the message display lists messages of highest priority first and messages of lowest priority last. For example, Agent #1 may have a sales profile, while Agent #2 may have an order or fulfillment related profile. As such, a message relating to sales (for example, focusing on a large order) may be prioritized higher for Agent #1 and a message relating to fulfillment (for example, focusing on shipping) may be prioritized higher for Agent #2. In this manner, the same set of messages may be displayed with different priorities and associated reasons for two different agents. Moreover, in embodiments, the reason or reasons or the primary reasons or reasons for prioritization of the message is provided in an easily understood format, such as text or message color. For example, the reason may be “Customer is requesting a large order” and it may be provided in a contrasting font color. In embodiments, the identified reason(s) or primary reason(s) for prioritization of a given message may differ from agent to agent. For example, a certain message may be related to placing a new order, as well as shipping for an existing order and as such may be prioritized highly for both Agent #1 and Agent #2, but the reason for the prioritization differs for each agent as does the displayed reason associated with the message in the view for Agent #1 as compared to the view for Agent #2. Other features of the message, such as receive time, customer name, message subject and the like may be displayed. Referring to FIG. 7, alternative prioritized message displays 700 and 702 for the two example agents described above are provided where messages are divided into a first section 704 for high priority messages and a second section 706 for unprioritized (or possibly lower priority) messages. The first section 704 for prioritized messages priorities the messages by listing the highest priority messages first and messages of lower priority last. Moreover, in embodiments, the reason or reasons or the primary reasons or reasons for prioritization of the message is provided in an easily understood format, such as text or message color as described above. Messages that are not prioritized are shown in the second section 706 for unprioritized messages and may be listed according to message information, such as a received date. In other embodiments, there may be no overlap in messages between the messages in the first section 704 and the messages in the second section 706, such that once a message is prioritized it is removed from the second section 706 and placed in a certain position in the first section 704. Other features of the messages, such as receive time, customer name, message subject and the like may be displayed.

In embodiments, the prioritization of messages may be based on one or more of many factors (which may also be referred to as data features). Overall, the prioritization logic may be optimizing for the highest probability of making a sale or the highest expected value of a sale (i.e. the probability of making a sale multiplied by the value of the sale). In embodiments, one factor may be customer identity, including whether the customer is a repeat or potential new customer, in general across merchants or with the given merchant. A repeat customer for a given merchant may be more likely to make an additional purchase and so may be prioritized ahead of customers who have not made a previous purchase. Another factor may be the location of the customer; for example, determined through an imputed location through a reverse IP lookup, GPS data, payment data and the like. A nearby customer or a customer in a known wealthy area may be prioritized ahead of others. Another factor may be customer demographics (including customer demographics in relation to typical customers of the products and/or services sold).

Another factor may be a customer's actual or type of previous purchase history; for example, including whether the customer has previously made large or small purchases and the categories of items purchased (such as consumer electronics or cosmetics). In embodiments, another factor may be the customer's previous messaging activity, such as recency of customer engagement and whether an active conversation is currently taking place. For example, if the customer previously sent a message within a set period of time (such as the past 24 hours). Any change in the mode of communication of the customer may also be considered; for example, if the customer has moved from lower paced email to higher paced text message or a phone call. Another factor may be demand trends in respect of certain, or certain categories of, products and/or services. For example, if a message relates to a category of product that is in high demand across merchants generally or for the particular merchant receiving the communication that communication may be considered higher priority. In embodiments, another factor for consideration may be the source of the communication, including a ranking across modes of communication. Communications received by a mode of communication that is typically asynchronous may be ranked lower than communications received by a mode of communication that is typically in real time. For example, messages received by text message may be ranked higher than messages received by email, as text message senders typically expect a response more quickly than email message senders. As another example, messages received via certain message platforms may be more likely to result in a sale; for example, if the message platform is a business focused platform where users have been previously vetted by the platform.

In embodiments, the prioritization of messages may be based on the content of the message; for example, as determined through natural language processing. In an embodiment, the communication component 129 scores message priority by determining the whether the message relates to popular items, relates to items which have higher margins, relates to customer service, relates to sales, relates to a potential further sale of a product or service related to a previously purchased product or service, relates to a product or service category's demand trends, a product's or service's overall likelihood to sell, product inventory, service availability, unit quantity requested or discussed, age of message, message platform, and whether the message content could be answered by an automated agent with a high degree of confidence that the automated answer is relevant. Further the prioritization can be based upon specific message wording, such as prioritizing based upon trigger words, such as “I am unhappy” to bring messages with certain subjective content to higher or lower prioritization.

In embodiments, the prioritization of messages may be based on attributes or a profile of the sender of the message, such as determined from the content of the message or based on other information. In embodiments, the profile of a user may take into account the past browsing history of a sender and how much time the sender has spent viewing the merchant's products and services.

In embodiments, the prioritization of messages may be based on aspects of the recipient of the message, including the addressed recipient and/or a merchant user to which a message may be routed. For example, if the recipient is a higher or lower level user, the technical role of the recipient, whether the recipient is full or part time, the tenure of the recipient, the work schedule of the recipient, whether the recipient is out of office, variations in the role of the recipient (for example, if the recipient works in returns on Mondays and works in sales on Wednesdays), and the number of previous messages answered by the recipient.

In embodiments, the prioritization of messages may be based on the age of the message. For example, an older message may be deemed higher priority than newer messages as the message ages. In another embodiment, older messages may be deemed higher priority than newer messages as the message ages, if the message meets a threshold level of priority. In another embodiment, older messages may be deemed lower priority than newer messages as the message ages, if the message does not meet a threshold level of priority. In yet another embodiment, messages may be ranked based upon the passage of time, based upon the mode of communication, such that messages received via one platform or mode of communication are deemed higher priority based upon the passage of time than messages received via another platform or mode of communication.

In embodiments, a communication may be given an absolute priority (or absolute nonpriority) or a subsort attribute, such as communications with a certain attribute always preempt, or are inferior to, others without the attribute and, optionally, are subsorted among themselves in a higher or lower rank.

In embodiments, combinations of factors may be used to prioritize messages as higher or lower priority. In embodiments, a scoring system may assign a priority score to a message based upon multiple factors. In embodiments, the factors upon which messages are assigned a priority may be modified by merchants and users. Further, the priorities may be used to order messages or to display the messages in an enhanced display, or combination of ordering and enhanced display. In further embodiments, factors can be used to preempt other factors or factors can be implemented as negative factors to de-prioritize a message. Factors may be given weights such that some factors have a greater effect upon priority scoring than other factors and such multiple applicable factor weights are summed to calculate a prioritization score.

In embodiments, the reason(s), or primary reason(s), for prioritization are identified to a message recipient, and the message recipient may sort and subsort messages according to the identified reason(s). In embodiments, the identified reasons could be the primary, secondary, etc. factors contributing to the prioritization score (and may include system factors, agent factors, scores, weights and combinations of these elements). In an embodiment, the primary reason driving the score is presented to the message recipient, for example, such that the factor with the highest score, or factor score multiplied by a factor weight, is identified is identified to the user.

In embodiments, rather than using the rules or scoring system described herein to determine message order or enhanced display of messages, the rules or scoring may be used to determine whether to display a message at all or the identity of a recipient to whom to route the message.

In embodiments, the score may also implement a time degradation factor, such that as a message ages, the weighting of the factor increases or decreases to cause the message to have prioritization score that is higher or lower with the passage of time.

In another embodiment, customer factors and message content are both used to prioritize messages or display messages in an enhanced display. In yet another embodiment, one or both of customer factors and message content are coupled with the age of a message to determine whether a message should remain displayed, be removed from the display or answered with an automated agent.

In an example message prioritization scenario, the message prioritization score is calculated using the sum of system prioritization factors and agent prioritization factors. In this scenario, prioritization factors are applied to a message in a binary fashion—that is, either the prioritization factor is applied to the message, or it is not. Exemplary system prioritization factors can include: time weight prioritization factors, customer profile weight prioritization factors, topic prioritization factors, supplement prioritization factors and mode of communication prioritization factors.

Time weight prioritization factors may be based upon an impending message or conversation expiration, a conversation age, a most recent message age, or any other factor based upon message timing. All prioritization weight factors may be positive weight factors to increase message priority or may be negative weight factors to decrease the message's priority. Reasons for the message's priority may optionally be displayed to a user as a message, such as “You have 12 hours left to respond to this customer.” or “This customer messaged 3 days ago.”

A predetermined system prioritization weight factor can be applied for the applicability of any reason that implicates the weight factor (such as the time weight factor) or different weights may be applied based upon the reason for applicability of the factor (e.g. different weights applied for the time weight factor for message expiration impending, conversation age over certain age, etc.).

Customer profile weight factors may be based upon customer profiles and customer types and used to increase priority of some customers over others. For example, a customer profile weight may be applied when a customer has a particular messaging history, such as the customer has previously messaged, has previously messaged within a period of time or the customer has recently purchased or made prior high-value purchase or has a long-term purchase history

Topic weight factors may prioritize a message based upon the content of the message, which may relate to an order, purchase intent or a general inquiry. For example, a topic weight may be applied when a customer messages about a particular item, about an item over a certain value, about purchasing multiple items or a large order, about specific previous or pending orders, about a refund, about an issue with an order, about an intent to purchase any item, about a product that is out of stock, about shipping options or related to any other predetermined topic.

Supplement weight factors may prioritize a message based upon the need to supplement a conversation or supplement a response to a message, such as based on new information, a change in status or a pre-set criterion being satisfied. For example, a supplement weight may be applied based upon product availability (e.g. a customer message relates to a specific product recently restocked), the existence of a new product (e.g. a customer would be interested in a new product that was recently added), a new discount (e.g. a customer did not previously purchase, but may be interested in a new discount or did previously purchase, but now may buy again or buy more with a new discount), or a customer message was intentionally ignored or “snoozed” (e.g. a customer agent snoozed a message or conversation) and now an elapsed period has expired.

Mode of communication or platform weight factors may prioritize the method of communication chosen by the customer to make contact, which may take into account the mode of communication, type of communication, gateway, communication channel or platform used, location of communication and the like. For example, a mode of communication weight may be weighted more when the mode of communication indicates a higher value customer or a more urgent mode of communication was selected. For example, a telephone message may be deemed more urgent than a text message. Further, for example, it may be known that likely higher value customers communicate via email messages than certain social media communication options and, hence, email communications weighted over social media communications or that a customer communicating via a business-to-business messaging platform should be prioritized.

A sample list of system prioritization weight factors and sample values for the factors are provided in Table 1 below.

TABLE 1
System Prioritization Factor Weights

1. Time (weight = 1.4)
2. Customer profile (weight = 1.3)
3. Topic (weight = 1.2)
4. Supplement (weight = 1.1)
5. Mode of Communication (weight = 1.0)

Agent prioritization weight factors may be based upon any factor of the agent (such as a merchant user or system, such as a bot) receiving the message or conversation. Example agent prioritization weight factors may include a conversation history weight factor, an expertise weight factor and neutral weight factor.

A conversation history weight factor may prioritize a conversation for the receiving agent if the agent has engaged in any conversation (or the present conversation) with the customer before or within a predetermined period of time. The factor could also be used to de-prioritized a message for an agent when the agent has had a negative previous experience with the customer.

An expertise weight factor may be applied if the agent has a particular expertise with the subject matter of the message. For example, the agent may be particularly trained with respect to the conversation, message content or customer type or the agent may fulfill a particular role that relates to the message type (customer support, fulfillment, shipping, etc.).

A neutral weight factor may be application when the agent has no particular interaction history or expertise with the message type or customer. This factor may be most relevant in embodiments where the agent prioritization weight factors are used as multipliers.

A sample list of agent prioritization weight factors and sample values for the factors are provided in Table 2 below.

TABLE 2
Agent Prioritization Factor Weights

1. Conversation history (weight = 2.0)
2. Expertise (weight = 1.5)
3. Neutral (weight = 1.0)

In embodiments, the system and agent prioritization factors weights and values may be determined in an automated fashion (such as by using machine learning) and possibly on a dynamic basis, may be set by a user and may be customized. In embodiments, the applicability of a factor may be determined on a binary basis or a factor may be assigned a score, where the score is then considered in respect of the weight for that factor, if there are differential weights among the factors. In other embodiments, certain of the factors, such as the agent factors, may function as multipliers and be used to multiply the score determined based on the system factors. In embodiments, of the agent factors the applicable factor with the highest weight, or score multiplied by weight, may be used as the sole multiplier to multiple the system factors score. In embodiments, the prioritization score for a conversation may be reflective of that conversation's potential to generate sales for the merchant.

In alternative embodiments, the above applicable factor weights could, rather than summed, all be multiplied by one another to arrive at a prioritization score. Alternatively, the applicable system prioritization factor weights could be summed, the applicable agent factors weights summed, and the two summed weights multiplied by one another to arrive at a prioritization score. Alternatively, all applicable weights could be multiplied to arrive at a message prioritization score. As described above, whether a factor applies in the forgoing embodiments, a binary decision is made to apply the factor or not. In embodiments, the binary decision may be based on a threshold determination by analyzing the conversation and determining whether the factor should apply based upon a predetermined logic for each factor and then determine the value of the factor based upon an analysis of the message. In such an embodiment a factor applies above a threshold, but in varying degrees after meeting the threshold.

In an example, the system prioritization factor weights apply system-wide and to all recipients. Agent prioritization factor weights are determined in respect of each recipient and may not apply system-wide. As a result, the prioritization of each message or conversation may be unique to each user-recipient (i.e. the relative prioritization of a given message may differ from agent to agent). In embodiments, agent factor weights could be preset, user-definable, or assigned based upon user job function, history of the agent, actions the agent has taken using the platform, previous message content of the agent, or automatically based upon machine learning.

In embodiments, a binary decision to apply the factor may be based on a threshold determination by analyzing the conversation and determining whether the weight factor should apply. If the weight factor should apply, then a premium factor may be established according to a determination logic and multiplied by the weight factor to determine the prioritization score. In such an embodiment, for each of the factors there is a scoring system (such as bounded scoring system, like 0 to 100, or an unbounded scoring system) to determine the premium factor. For example, suppose the time weight factor applied to a message and three days had elapsed since receipt of the message so that, for example, a premium factor of 20 is multiplied by the time weight factor. If a longer period had expired, for example, a higher premium factor could be assigned and multiplied by the time weight factor.

In embodiments, the agent prioritization factor could be based upon a real person as agent or an automatic reply bot as agent, or the agent factor could determine whether the message should be replied to by a real person or a bot. Additionally, agent prioritization factors can be applied according to the binary decision described herein or with the application of a premium factor as described herein.

Therefore, in an example embodiment of message prioritization two agents have received three messages to which replies are required. Agent 1 fulfills a technical role and Agent 2 fulfills a sales role. In the example, the system prioritization score is calculated by summing system prioritization weight factors and summing agent prioritization weight factors. In the example, whether a weight factor applies is a binary decision without a premium factor. Using the scores above, for the system prioritization score, Message 1 satisfies the time prioritization factor and the supplement prioritization factor (1.4+1.1=2.5). Message 2 satisfies the time prioritization factor and customer profile prioritization factor (1.4+1.3=2.7). Message 3 satisfies only the supplement prioritization factor (1.1).

For Message 1, Agent 1 has conversed with the customer previously, and Agent 2 has no previous history with the customer or expertise with respect to Message 1. For Message 2, Agent 2 has particular expertise, and Agent 1 has no previous history or expertise. For Message 3, neither agent has had previous conversation nor particular expertise with respect to Message 3. Therefore, the sort order of priority and calculation of prioritization score for each agent is as set forth in Table 3.

TABLE 3

| | Priority | Agent | Prioritization | | Priority | Agent | Prioritization |
|---|---|---|---|---|---|---|---|
| Agent 1 | Score | Score | Score | Agent 2 | Score | Score | Score |
| Msg 1 | 2.5 | 2.0 | 4.5 | Msg 2 | 2.7 | 1.5 | 4.2 |
| Msg 2 | 2.7 | 1.0 | 3.7 | Msg 1 | 2.5 | 1.0 | 3.5 |
| Msg 3 | 1.1 | 1.0 | 2.1 | Msg 3 | 1.1 | 1.0 | 2.1 |

As can be seen from Table 3, message ordering for Agent 1 is—Message 1, Message 2, Message 3. For Agent 2, message ordering is Message 2, Message 1, Message 3. Further to the example, presume a fourth message arrives that satisfies the mode of communication prioritization weight and customer profile prioritization weight (1.0+1.3=2.3). Agent 1 has both expertise with the message content and conversation history. The new message order would be as in Table 4.

TABLE 4

| | Priority | Agent | Prioritization | | Priority | Agent | Prioritization |
|---|---|---|---|---|---|---|---|
| Agent 1 | Score | Score | Score | Agent 2 | Score | Score | Score |
| Msg 4 | 2.3 | 3.5 | 5.8 | Msg 2 | 2.7 | 1.5 | 4.2 |
| Msg 1 | 2.5 | 2.0 | 4.5 | Msg 1 | 2.5 | 1.0 | 3.5 |
| Msg 2 | 2.7 | 1.0 | 3.7 | Msg 4 | 2.3 | 1.0 | 3.3 |
| Msg 3 | 1.1 | 1.0 | 2.1 | Msg 3 | 1.1 | 1.0 | 2.1 |

As can be seen from Table 4, message ordering for Agent 1 is—Message 4, Message 1, Message 2, Message 3. For Agent 2, message ordering is Message 2, Message 1, Message 4, Message 3.

In embodiments, the prioritizations described herein may be determined based on rules, such as by a rules engine. In other embodiments, an artificial intelligence or machine learning algorithm may be implemented to determine relevant factors or data features (such as customer factors, message factors or recipient factors) that contribute the increased sales and prioritize messages based upon the determined factors. In other embodiments, natural language processing may be used to derive information and data based on the content and associated metadata for a given communication.

In embodiments, an automated agent or bot may communicate on behalf of a merchant or assist a merchant, thereby possibly creating more apparent interaction between a merchant and a customer. In embodiments, the automated agent may reply to the lowest priority messages in certain instances and to the highest priority messages in other instances, such as where the automated agent has a high success rate at responding to a particular type of query and the communication is highly prioritized. In another embodiment, messages deemed to have high priority are responded to with automated messages which attempt to answer questions presented within the message. In other embodiments, messages that are identified as important, but not replied to by a user within a certain period of time (such as within a certain number of minutes of receipt of the message), while the user is not working, based upon the message platform upon which the message is received (such as where a particular message platform has a requirement, recommendation or convention for how quickly a response should be provided), or based upon the volume of messages received are responded to by an automated agent.

In yet another alternative embodiment, messages may be addressed by an automated agent based on whether the messages have a priority score below a certain threshold, when the number of messages exceeds a threshold number of messages or exceeds a threshold number of messages per available seller-responder that is configurable based upon external variables such as based upon time of day, day of week, proximity to a holiday, based upon the number of seller-responders presently available or working or that will be available in the future or based on the volume of communications received in a period of time. For example, an automated agent may respond when it is known that the seller-responder is not within scheduled working hours. In other embodiments, a decision as to whether an automated agent should address a particular communication may consider whether an automated message was previously provided and whether the automated message successfully or unsuccessfully addressed the message.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A computer-implemented method for identifying a message priority, comprising:
receiving a plurality of messages;
for each message, assigning a message priority based upon at least one of a message content, a recipient identity, a sender identify, a messaging platform of the message and a message age;
displaying the messages according to the assigned message priority of the message; and
wherein the message priority is at least partially based upon factors relating to the recipient of the message in relation to at least one of the content of the message and the identity of the sender.

2. The method of claim 1 wherein the step of displaying the messages according to the assigned message priority of the message comprises displaying the message according to the assigned message priority of the message by ordering the messages according to rules of priority.

3. The method of claim 1 wherein the step of, for each message, assigning a message priority based upon at least one of a message content, a recipient identity, a sender identify, a messaging platform of the message and a message age comprises assigning a score to the message based upon at least one of the message content, the recipient identity, the sender identify, the messaging platform of the message and the message age.

4. The method of claim 1 further comprising the step of determining whether to respond to one or more of the plurality of messages with an automated agent based upon the assigned priority.

5. The method of claim 1 wherein the plurality of messages are received over a plurality of messaging platforms.

6. The method of claim 1 wherein the message priority is a score calculated from a first score based upon organizational message priority and a second score based upon agent message priority based upon the factors relating to the recipient of the message

7. A device comprising a processor and a computer-readable storage device that stores instructions that, when executed by the processor, cause the processor to perform operations comprising:
receiving a plurality of messages;
for each message, assigning a message priority based upon at least one of a message content, a recipient identity, a sender identify, a messaging platform of the message and a message age;
displaying the messages according to the assigned message priority of the message; and
wherein the message priority is at least partially based upon factors relating to the recipient of the message in relation to at least one of the content of the message and the identity of the sender.

8. The device of claim 7 wherein the operation of displaying the messages according to the assigned message priority of the message comprises displaying the message according to the assigned message priority of the message by ordering the messages according to rules of priority.

9. The device of claim 7 wherein the operation of, for each message, assigning a message priority based upon at least one of a message content, a recipient identity, a sender identify, a messaging platform of the message and a message age comprises assigning a score to the message based upon at least one of the message content, the recipient identity, the sender identify, the messaging platform of the message and the message age.

10. The device of claim 7 further comprising causing the processor to perform operations comprising determining whether to respond to one or more of the plurality of messages with an automated agent based upon the assigned priority.

11. The device of claim 7 wherein the plurality of messages are received over a plurality of messaging platforms.

12. The device of claim 7 wherein the message priority is a score calculated from a first score based upon organizational message priority and a second score based upon agent message priority based upon the factors relating to the recipient of the message.

13. A computer-implemented method, the method comprising:
receiving a plurality of messages relating to purchasing of products or services;
assigning a message priority to each message based upon at least one of a message content, a recipient identity, a sender identify, a messaging platform of the message and a message age;
identifying keywords associated with the message for purchasing of the products or services;
categorizing the keywords associated with the message;
determining a response to the message based upon the categorization of the keywords;
developing a confidence level for the keywords that indicate a statistical probability that an answer is relevant to the message; and
transmitting the response if the confidence level for the keywords exceeds a predetermined confidence level.

14. The method of claim 13 wherein the step of assigning a message priority based upon at least one of a message content, a recipient identity, a sender identify, a messaging platform of the message and a message age comprises assigning a score to the message based upon at least one of the message content, the recipient identity, the sender identify, the messaging platform of the message and the message age.

15. The method of claim 13 further comprising the step of determining whether to respond to one or more of the plurality of messages with an automated agent based upon the assigned priority.

16. The method of claim 15 wherein the message priority is a score calculated from a first score based upon organizational message priority and a second score based upon agent message priority based upon factors relating to the automated agent.

17. The method of claim 13 wherein the plurality of messages are received over a plurality of messaging platforms.

18. A system comprising:
a processor and a computer-readable storage device that stores instructions that, when executed by the processor, cause the processor to perform operations comprising:
transmitting to a client device data to display a plurality of messages related to a product or service for purchase from an online merchant,
wherein the data includes software instructions for execution by the client device,
wherein the software instructions cause the client device to perform steps for assigning a message priority to each message based upon at least one of a message content, a recipient identity, a sender identify, a messaging platform of the message and a message age; and for displaying the plurality of messages, and
wherein the software instructions cause the client device to display the plurality of messages according to the assigned message priority of each message.

19. The system of claim 18 wherein the software instructions causing the client device to display the plurality of messages comprises software instruction causing the client device to display the messages according to the assigned message priority of each message by ordering the messages according to rules of priority.

20. The system of claim 18 wherein the software instructions causing the client device to, for each message, assign a message priority based upon at least one of a message content, a recipient identity, a sender identify, a messaging platform of the message and a message age comprises software instruction causing the client device to assign a score to the message based upon at least one of the message content, the recipient identity, the sender identify, the messaging platform of the message and the message age.

21. The system of claim 18 wherein the software instructions causing the client device to determine whether to respond to one or more of the plurality of messages with an automated agent based upon the assigned priority.

22. The system of claim 18 wherein the plurality of messages are received over a plurality of messaging platforms.

23. The system of claim 18 wherein the message priority is a score calculated from a first score based upon organizational message priority and a second score based upon agent message priority based upon factors relating to the recipient of the message.
